(19) United States
(12) Patent Application Publication
(10) Pub. No.: US 2009/0100874 A1
(43) Pub. Date: Apr. 23, 2009

(54) GLASS STRIP MANUFACTURING METHOD

(75) Inventors: Toshiaki TATEISHI, Tokyo (JP); Yasuhiro NAKA, Tokyo (JP); Tetsuya KUMADA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE FURUKAWA ELECTRIC CO., LTD., Chiyoda-ku (JP)

(21) Appl. No.: 12/336,573

(22) Filed: Dec. 17, 2008

Related U.S. Application Data
(63) Continuation of application No. PCT/JP07/68696, filed on Sep. 26, 2007.

(30) Foreign Application Priority Data
Sep. 26, 2006 (JP) 2006-260457

(51) Int. Cl. C03B 29/04

(52) U.S. Cl. 65/106

(57) ABSTRACT

A glass strip manufacturing method includes heat-drawing a preform glass plate by softening the preform glass plate with heat and drawing the preform glass plate down to a desired thickness. The preform glass plate has a level of transmittance that allows radiant heat absorbed therein while passing therethrough to diffuse before locally accumulating therein. The minimum transmittance of the preform glass plate in a thickness of 3 millimeters at a wavelength of 800 to 2200 nanometers is 86 to 95%.

### CROSS-REFERENCE TO RELATED APPLICATIONS

This application is a continuation of PCT/JP2007/068696 filed on Sep. 26, 2007, the entire content of which are incorporated herein by reference.

### BACKGROUND OF THE INVENTION

1. Field of the Invention

The present invention relates to a glass strip manufacturing method for manufacturing a sheet glass strip.

2. Description of the Related Art

It has been important that glass plates used for, for example, a semiconductor device substrate, a spacer of a field-effect flat panel display, and a magnetic disk substrate, have desired flatness and surface roughness. However, a sheet glass plate manufactured by a floating method or a molding method currently used as a common method of manufacturing a glass plate has a low flatness. Therefore, it is required to grind and polish a substantial amount of a surface of the manufactured glass plate to obtain a flatness suitable for the above use. This significantly decreases the surface roughness of the glass plate after polishing.

To solve the problem, generally, the glass plate is polished two times after being ground such that the surface roughness is about 0.5 nm after first polishing and is about 0.1 nm after second polishing. It is expected that more sophisticated glass plates will be needed in the future, and thus third polishing will be additionally required. To increase the flatness of a glass plate by grinding and polishing only, more time and operation are required, which results in an increase in cost.

With such background, for example, Japanese Patent Application Laid-open Nos. H11-199255, H8-183627, and 2004-67393 have proposed a conventional technologies for manufacturing a sheet glass plate having a desired thickness by heating a preform glass plate having a predetermined thickness and preferable surface roughness to soften it and drawing it into a glass plate.

However, in the case of obtaining, for example, a sheet glass strip having a thickness of 0.7 mm or less by heating a preform glass plate to soften and draw it, the glass strip is likely to curve and the flatness thereof decreases.

### SUMMARY OF THE INVENTION

It is an object of the present invention to at least partially solve the problems in the conventional technology.

According to an aspect of the present invention, there is provided a glass strip manufacturing method including heat-drawing a preform glass plate by softening the preform glass plate with heat and drawing the preform glass plate down to a predetermined thickness. The preform glass plate has transmittance that allows radiant heat absorbed in the preform glass plate while passing through the preform glass plate to diffuse before locally accumulating in the preform glass plate.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a heat-drawing device according to an embodiment of the present invention;

FIG. 2 is a plane view and a cross section of a heating furnace shown in FIG. 1;

FIG. 3 is a graph of spectrum of transmittance of preform glass plates of Examples 1 to 3 and Comparative Examples 1 and 2;

FIG. 4 is a diagram for explaining an amount of warping of a glass strip;

FIG. 5 is a table of characteristics of preform glass plates and glass strips of Examples 1 to 6 and Comparative Examples 1 to 3; and

FIG. 6 is a graph of a relation between transmittance of a preform glass plate and an amount of warping of a glass strip.

### DETAILED DESCRIPTION OF THE PREFERRED EMBODIMENTS

Exemplary embodiments of the present invention are explained in detail below with reference to the accompanying drawings.

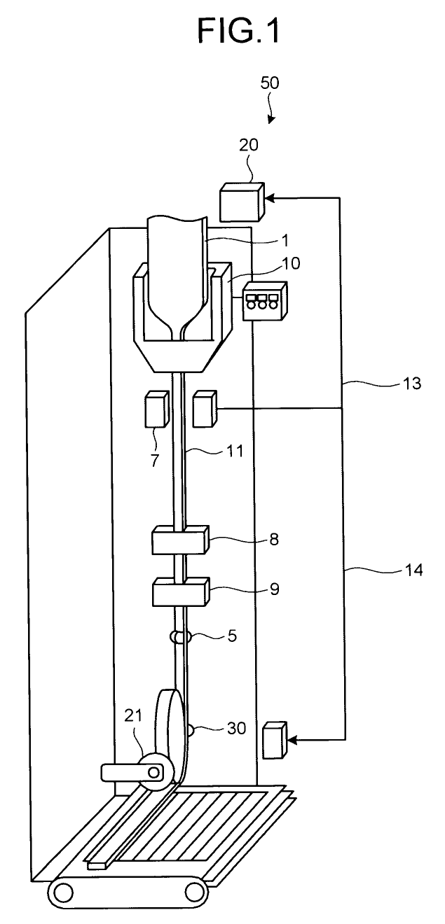

FIG. 1 is a perspective view of a heat-drawing device 50 according to an embodiment of the present invention. The heat-drawing device 50 includes a heating furnace 10 that is an electric resistance furnace for heating a preform glass plate 1, a preform conveying mechanism 20 that conveys the preform glass plate 1 into the heating furnace 10, and a drawing mechanism 30 that draws a glass strip 11 from the heating furnace 10. The heating furnace 10 includes a plurality of heaters as a heating unit that heats the preform glass plate 1. Below the heating furnace 10 are arranged an external shape measuring unit 7 for measuring an external shape of the glass strip 11, a protection film forming device 8 that forms a protection film on a surface of the glass strip 11, a tension measuring unit 9 that measures a tension with which the glass strip 11 is drawn, and a guide roller 5 that prevents the glass strip 11 from twisting. At a lower position of the drawing mechanism 30 is arranged a cutter 21 for forming a groove on a surface of the glass strip 11 to cut it into pieces having a predetermined length. A value obtained by the shape measuring unit 7 is sent to the preform conveying mechanism 20 as a feedback value via a feedback path 13. The preform conveying mechanism 20 controls preform-conveying speed based on the feedback value. The value is also sent to the drawing mechanism 30 as a feedback value via a feedback path 14. The drawing mechanism 30 controls drawing speed based on the feedback valued.

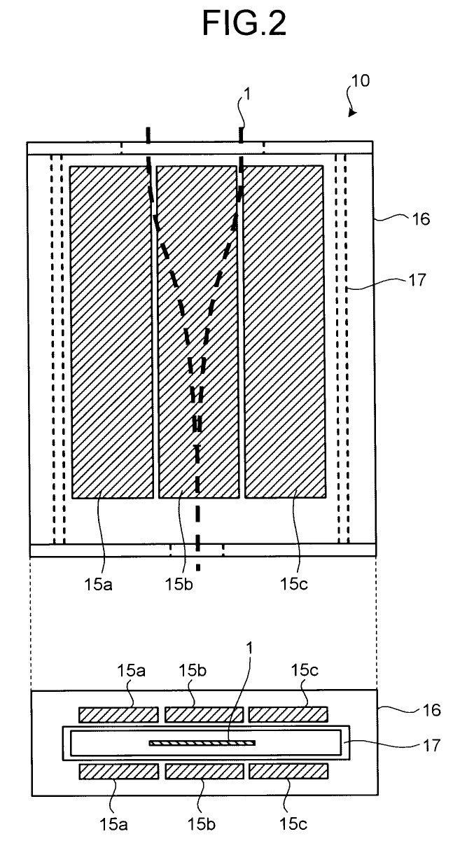

FIG. 2 is a plane view and a cross section of the heating furnace 10. In a furnace body 16, as shown in FIG. 2, the preform glass plate 1 is surrounded by a rectangular furnace tube 17. A plurality of heaters 15a to 15c is arranged on both sides of the preform glass plate 1 and at an outer side of the furnace tube 17. For example, a carbon resistance heating element can be used for the heaters. It is preferable that the heaters be protected with an inert gas to be prevented from corroding.

In the glass strip manufacturing method according to the embodiment, the preform glass plate 1 is set in the heat-drawing device 50 and the heaters 15a to 15c are turned on. Accordingly, radiant heat is emitted from the heaters 15a to 15c, and is partly absorbed in the preform glass plate 1 while passing through it, and thereby the preform glass plate 1 is heated. When the preform glass plate 1 is heated to a temperature above a melting point, the preform glass plate 1 softens and melts. Thus, as the width of the preform glass plate 1 reduces, the preform glass plate 1 is drawn to a desired thickness. Through this heat-drawing process, the glass strip 11 having a desired thickness and width is formed.

The preform glass plate 1 has a level of transmittance that allows radiant heat absorbed therein to diffuse before locally accumulating therein. This limits the amount of radiant heat absorbed in the preform glass plate 1. Because the absorbed radiant heat diffuses in the preform glass plate 1 faster than a speed at which the radiant heat increases the temperature of the preform glass plate 1, local accumulation of heat can be avoided in the preform glass plate 1. Therefore, temperature variation is less likely to occur. As a result, thermal expansion is less likely to vary in the preform glass plate 1, which suppresses warping of the glass strip.

When manufacturing a glass strip using a rectangular heating furnace like the heat-drawing device 50, the amount of radiant heat emitted from heaters may be different between front and back sides of a preform glass plate. However, according to the embodiment, even if the amount of radiant heat is different between the front and back sides of a preform glass plate, the temperature difference is less likely to occur between the front and back sides. This suppresses warping of the glass strip.

If the minimum transmittance of a preform glass plate in a thickness of 3 mm at a wavelength of 800 to 2200 nm is 86% or more, an infrared ray absorbed in the preform glass plate at a wavelength within the above range diffuses in the preform glass plate faster than a speed at which the infrared ray locally increases the temperature of the preform glass plate. This reliably suppresses warping of a glass strip.

However, if the transmittance of a preform glass plate at a wavelength within the above range is too high, the amount of heating by radiant heat emitted from the heaters is small. Thus, the heating due to heat conduction from, for example, the atmospheric gas to the preform glass plate in the heating furnace is relatively large. It is difficult to obtain uniform spatial distribution of the conduction heating compared with the radiant heating. Therefore, increase in the amount of conduction heating increases temperature variation in the preform glass plate, thereby causing warpage and the like. This makes it difficult to perform a drawing process while the shape of a glass strip is maintained stable. For this reason, to keep the amount of radiant heating larger than a predetermined amount, it is preferable that the minimum transmittance at a wavelength within the above range be 95% or less. Examples 1 to 6 and Comparative Examples 1 to 3

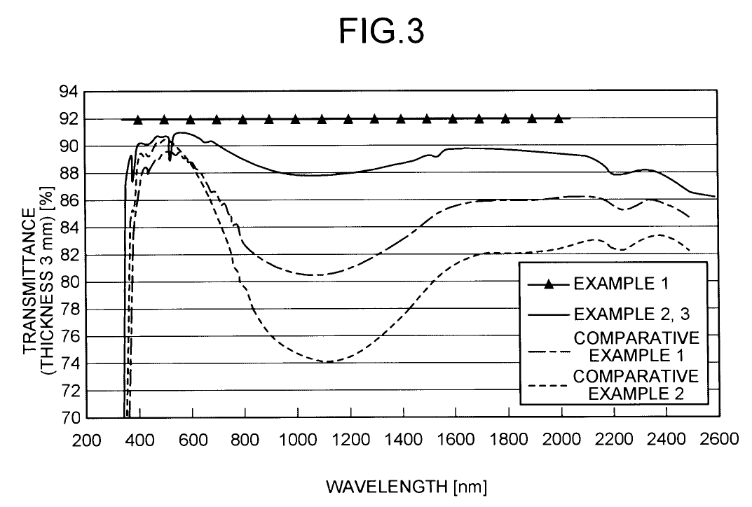

As Example 1 was prepared a perform glass plate made of borosilicate glass (TEMPAX Float® manufactured by Schott Glaswerk) and having a width of 308 mm, a thickness of 2.8 mm, a length of about 1.15 m, and a cross-sectional aspect ratio of 110. The cross-sectional aspect ratio is a ratio between the width and the thickness of the preform glass plate in its cross section. FIG. 3 is a graph of spectrum of transmittance of the preform glass plate of Example 1, and those of Examples 2 and 3 and Comparative Examples 1 and 2, explained later. As shown in FIG. 3, the minimum transmittance of the preform glass plate of Example 1 in a thickness of 3 mm at a wavelength of 800 to 2200 nm was 92%. The preform glass plate is heated and drawn to manufacture a glass strip using a heat-drawing device as shown in FIG. 1.

In the Example 1, carbon heaters each having a length of 620 mm and a width of 256 mm were used as heaters arranged in a heating furnace of the heat-drawing device. The heaters were positioned as shown in FIG. 2 such that distance between center lines of adjacent heaters was 277 mm. The heater arranged at the center had a heating temperature of 900° C. and the heaters arranged on both sides thereof have a heating temperature of 1100° C. By setting the heating temperatures of the heaters in this manner, the preform glass plate is heated to have a temperature distribution of a concave shape in its width direction. Thus, a glass strip has uniform thickness in the width direction. Drawing conditions were set as follows: drawing speed was 4 mm/min, and the glass strip obtained by drawing had a width of 42 mm, a thickness of 0.4 mm, and a cross-sectional aspect ratio of 105. If the cross-sectional aspect ratio is 50 or more, the thickness thereof is 0.7 mm or less, or both are applied, even small warping significantly influences the overall shape of the glass strip. Therefore, the flatness is significantly improved in Example 1.

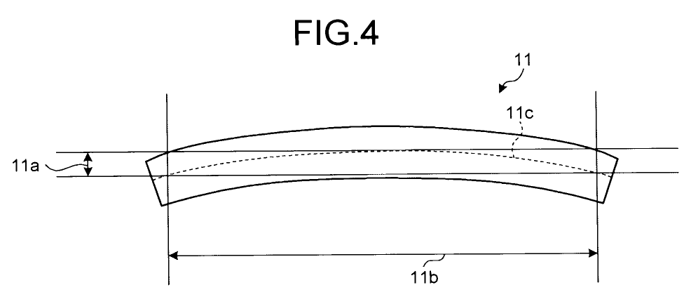

Next, evaluation was performed on warping of the glass strip manufactured as above based on the amount of warping as an index. FIG. 4 is a side view of a glass substrate obtained by processing the glass strip 11 obtained by the heat-drawing process into a desired shape for explaining an amount of warping. An amount of warping 11a indicates a distance between two points, i.e., the highest and lowest points in the vertical direction, on a center line 11c, one separated from the other by a distance 11b, of a substrate having a desired area cut out of the glass strip 11 on a horizontal plane. The amount of warping was measured with a surface shape measuring device (CS5000 manufactured by Mitutoyo Corporation). The distance between the two points was set to 20 mm.

After the measurement, it was found that the glass strip of Example 1 had an amount of warping of 1.5 μm, i.e., a glass strip having excellent flatness was manufactured.

As Comparative Example 1 was prepared a preform glass plate made of aluminum silicate glass and having a width of 308 mm, a thickness of 2.8 mm, a length of about 1.15 m, and a cross-sectional aspect ratio of 110. As shown in FIG. 3, the minimum transmittance of the preform glass palate of Comparative Example 1 in a thickness of 3 mm at a wavelength of 800 to 2200 nm was 80%. A glass strip was manufactured in the same manner as described previously for Example 1. The cross section of the glass strip had a convex shape and a significantly large amount of warping of 15 μm.

In the same manner for Example 1 and Comparative Example 1, glass strips of Examples 2 to 6 and those of Comparative Examples 2 and 3 were manufactured from preform glass plates having different characteristics. The heating temperature was set to correspond to a melting point of each preform glass plate. Each preform glass plate was heated such that the preform glass plate had a temperature distribution of a concave shape in its width direction.

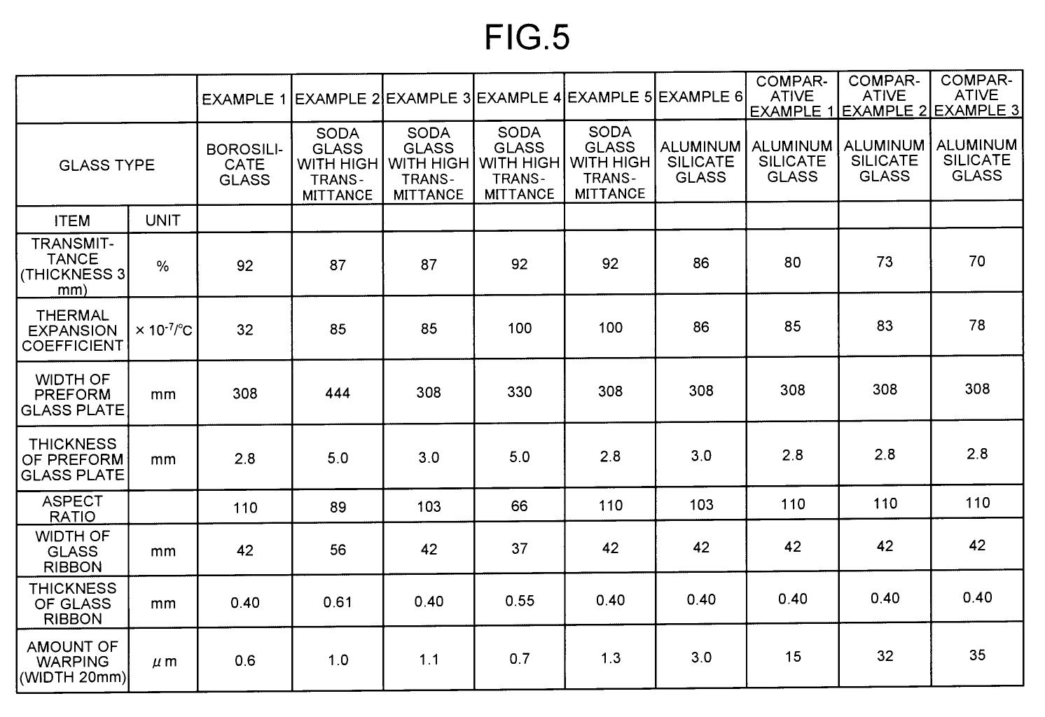

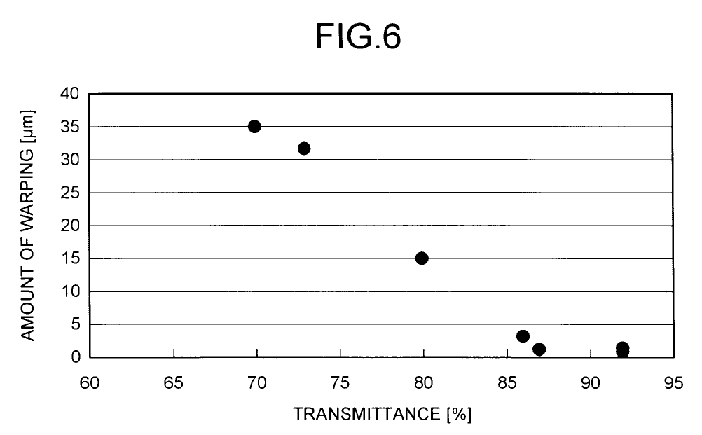

FIG. 5 is a table of characteristics of the glass plates and the glass strips of Examples 1 to 6 and Comparative Examples 1 to 3. FIG. 6 is a graph of relation of transmittance of the preform glass plate and the amount of warping of the glass strip. As shown in FIGS. 5 and 6, the minimum transmittance of the preform glass plates of Examples 1 to 6 in a thickness of 3 mm at a wavelength of 800 and 2200 nm is 86 to 92%. Therefore, the glass strips manufactured from the preform glass plates had a preferable amount of warping of 3.0 μm or less. On the other hand, the preform glass plates of Comparative Examples 1 to 3 had the minimum transmittance of 70 to 80% at a wavelength within the above range. Therefore, the glass strips manufactured from the preform glass plates had a significantly large amount of warping of 15 μm or more.

Particularly, although the preform glass plates of Examples 4 and 5 had a high thermal expansion coefficient of 100×10⁻⁷/° C., the glass strips manufactured from them had a significantly small amount of warping compared with those of Comparative Examples 1 to 3 having a thermal expansion coefficient lower than that of Examples 4 and 5. In other words, the preform glass plates of Examples 4 and 5 had a level of transmittance that allows radiant heat absorbed therein to diffuse in the preform glass plates before locally accumulating therein. Accordingly, the thermal expansion amount is less likely to vary in the preform glass plates. Therefore, it is assumed that the glass strips had a favorable amount of warping even though the thermal expansion coefficient was high.

As explained above, according to the embodiment, temperature variation is less likely to occur in a preform glass plate in the heat-drawing process, and thus thermal expansion amount is less likely to vary. Therefore, it is possible to manufacture a glass strip having little warping and excellent flatness.

There is no particular limitation on, for example type, size, and thickness of the preform glass plate. As a material of the preform glass plate can be used, for example, aluminosilicate glass, soda-lime glass, soda-alumina silica glass, alumino borosilicate glass, borosilicate glass, physically reinforced glass subjected to a process such as wind cooling or liquid cooling, or chemically reinforced glass. As an amount of Fe₂O₃ contained in the preform glass plate increases, the preform glass plate becomes deeper blue, and the minimum transmittance at a wavelength in the above range decreases. By adjusting the amount of Fe₂O₃, desirable transmittance can be achieved.

If silica glass is used, a functional film can be deposited on a surface of a preform glass plate by thermal chemical vapour deposition (CVD) taking advantage of its heat resistance. When multi-component glass is used, a functional film can be deposited on a surface of a preform glass plate through a low-temperature process. Depending on purposes, the glass strip can be cut into a polygonal, circular, or disk-like shape and used as a glass substrate. Further, the glass substrate thus obtained can be polished.

As set forth hereinabove, according to an embodiment of the present invention, temperature variation is less likely to occur and variation in thermal expansion is small in a preform glass plate. Thus, a glass strip having excellent flatness and little warpage can be manufactured.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A glass strip manufacturing method comprising:
heat-drawing a preform glass plate by softening the preform glass plate with heat and drawing the preform glass plate down to a predetermined thickness, wherein
the preform glass plate has transmittance that allows radiant heat absorbed in the preform glass plate while passing through the preform glass plate to diffuse before locally accumulating in the preform glass plate.

2. The glass strip manufacturing method according to claim 1, wherein minimum transmittance of the preform glass plate in a thickness of 3 millimeters at a wavelength of 800 to 2200 nanometers is 86 to 95%.

3. The glass strip manufacturing method according to claim 1, wherein the preform glass plate has a cross-sectional aspect ratio equal to or greater than 50.

4. The glass strip manufacturing method according to claim 1, wherein the heat-drawing includes drawing the preform glass plate down to a thickness equal to or less than 0.7 millimeter.
